(19) United States
(12) Patent Application Publication
(10) Pub. No.: US 2025/0381861 A1
(43) Pub. Date: Dec. 18, 2025

(54) UNIVERSAL CHARGING CONFIGURATION

(71) Applicant: ADDÉNERGIE TECHNOLOGIES INC., Quebec City (CA)

(72) Inventors: Abel ZACHARIE, Quebec (CA); Maxime DAIGLE, Quebec City (CA)

(73) Assignee: ADDÉNERGIE TECHNOLOGIES INC., Quebec City (CA)

(21) Appl. No.: 18/745,225

(22) Filed: Jun. 17, 2024

(51) Int. Cl. B60L 53/16; B60L 53/60

(52) U.S. Cl. CPC B60L 53/16; B60L 53/60

(57) ABSTRACT

An electric vehicle (EV) charger and methods of use thereof are disclosed. The EV charger includes a first port configured for a first charging system and a second port configured for a second charging system. The EV charger also includes a detection circuit coupled to the first port and the second port, the detection circuit being configured to detect whether the first charging system or the second charging system is to be in use, and a switch for selectively routing power through the first port when the second charging system is detected to be in use, and through the second port when the first charging system is detected to be in use.

### TECHNICAL FIELD

This application relates to electric vehicle chargers and to methods for controlling operation of electric vehicle chargers.

### BACKGROUND

An electric vehicle (EV) charging station is an element of infrastructure that supplies direct current (DC) or alternating current (AC) electric energy for the recharging of electric vehicles, such as plug-in battery electric vehicles, including electric cars, trucks, buses, and other vehicles including high and low range electric vehicles and plug-in hybrids.

To provide power to an electric vehicle, an EV charger of an EV charging station must be compatible with the electric vehicle. However, electric vehicles may be manufactured under one of multiple different charging systems, and thus have different vehicle inlets or ports for recharging. If an EV charger was made for/under a different charging system, it would be incompatible with the electric vehicle, and would not be able to charge the electric vehicle that operates under the different charging system.

Some existing EV charging stations address this issue by incorporating an adaptor that a user may optionally deploy at the EV charger by requesting its use from an affiliated application on the user's device. However, such a system would be dependent on the reliability of the user's device, the application itself, the network connection, and the mechanical robustness of an intermittently connected adaptor.

### BRIEF DESCRIPTION OF THE DRAWINGS

Reference will now be made, by way of example, to the accompanying drawings which show example implementations of the present application and in which:

FIG. 1 is a front view of an example implementation of an electric vehicle (EV) charger;

FIG. 2 is a high-level schematic diagram of internal components of the EV charger of FIG. 1 in communication with an example EV charging station;

FIG. 3 is a front view of the EV charger of FIG. 1 in a first charging configuration;

FIG. 4 is a front view of the EV charger of FIG. 1 in a second charging configuration;

FIG. 5 shows, in flowchart form, an example method for operating the EV charger of FIG. 1;

FIG. 6 shows, in flowchart form, another example method for operating the EV charger of FIG. 1; and

FIG. 7 shows, in flowchart form, another example method for operating the EV charger of FIG. 1.

Like reference numerals are used in the drawings to denote like elements and features.

### SUMMARY OF THE INVENTION

The present application discloses an EV charger that is compatible with multiple charging standards by having two (or more) female ports connectable by a single cable.

In an aspect, the present disclosure describes an EV charger comprising: a first port configured for a first charging system; a second port configured for a second charging system; a detection circuit coupled to the first port and the second port, the detection circuit configured to detect whether the first charging system or the second charging system is to be in use; and a switch for selectively routing power through the first port when the second charging system is detected to be in use, and through the second port when the first charging system is detected to be in use.

In some implementations, the EV charger may further comprise a cable configured to couple at one end to the first port and at another end to the second port.

In some implementations, the EV charger may further comprise a temperature sensor; and a controller coupled to the temperature sensor and a power source, the controller configured to, based on a temperature reading at the temperature sensor, send a signal to the power source to provide power to the cable when the cable is connected to the first port and the second port.

In some implementations, the temperature sensor may be operatively coupled to the cable to detect the temperature reading of the cable.

In some implementations, the EV charger may further comprise an impedance detector for measuring an impedance of the cable when the cable is connected to the first port and the second port; and a controller configured to trigger a notification when the impedance of the cable indicates deterioration of the cable.

In some implementations, the EV charger may further comprise a first connector coupled to the one end of the cable and releasably securable to the first port, the first connector configured to releasably couple with an EV to charge the EV under the first charging system; and a second connector coupled to the other end of the cable and releasably securable to the second port, the second connector configured to releasably couple with another EV to charge the other EV under the second charging system.

In some implementations, the EV charger may further comprise a locking mechanism operatively coupled to the first port and the second port, the locking mechanism configured to selectively lock the first connector to the first port and lock the second connector to the second port when the first port and the second port are detected to not be in use.

In some implementations, the EV charger may further comprise a controller coupled to the locking mechanism, the controller configured, based on completion of an authentication protocol, to send a signal to the locking mechanism to unlock at least one of the first connector from the first port and the second connector from the second port.

In some implementations, the controller is configured, based on a charging system selection, to send the signal to the locking mechanism to unlock the first connector from the first port when the first charging system is selected, or to unlock the second connector from the second port when the second charging system is selected.

In some implementations, the EV charger may further comprise an indicator coupled to the locking mechanism configured to indicate which of the first and second connector is unlocked.

In some implementations, the EV charger may further comprise a cable management system coupled to the cable; and a controller coupled to the cable management system, the controller configured to send a signal to the cable management system to selectively extend or retract the cable based on a charging system selection.

In another aspect, the present disclosure describes a processor-implemented method. The method comprises determining whether a first charging system or a second charging system of an EV charger is to be in use, the EV charger having a first port configured for the first charging system, and a second port configured for the second charging system; and in response to the determination, selectively routing power through the first port when the second charging system is detected to be in use, and through the second port when the first charging system is detected to be in use.

In some implementations, the first port is connectable to the second port via a cable extending therebetween.

In some implementations, the method further comprises obtaining a temperature reading from a temperature sensor; and providing power to the cable when the temperature reading falls below a predetermined threshold, and when the cable is connected at the first port and the second port.

In some implementations, the method further comprises obtaining an impedance of the cable when the cable is connected at the first port and the second port; and triggering a notification when the impedance of the cable indicates deterioration of the cable.

In some implementations, a first connector is coupled to one end of the cable and is releasably securable to the first port, the first connector being configured to releasably couple with an EV to charge the EV under the first charging system; and wherein a second connector is coupled to another end of the cable and releasably securable to the second port, the second connector being configured to releasably couple with another EV to charge the other EV under the second charging system.

In some implementations, the method further comprises locking the first connector within the first port and locking the second connector within the second port when the EV charger is detected to not be in use.

In some implementations, the method further comprises selectively unlocking the first connector from the first port when the first charging system is detected to be in use, and selectively unlocking the second connector from the second port when the second charging system is detected to be in use.

In some implementations, the method further comprises receiving indication of completion of an authentication protocol; and unlocking at least one of the first connector from the first port and the second connector from the second port.

In another aspect, the present disclosure describes a non-transitory computer-readable medium. The non-transitory computer-readable medium stores instructions that, when executed by a processor of an EV charger, causes the processor to: obtain a detecting signal indicating whether a first charging system or a second charging system of the EV charger is to be in use, the EV charger having a first port configured for the first charging system, and a second port configured for the second charging system; and in response to the detecting signal, selectively route power through the first port when the second charging system is detected to be in use, and through the second port when the first charging system is detected to be in use.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

### DETAILED DESCRIPTION OF EXAMPLE IMPLEMENTATIONS

There are currently multiple major standards worldwide for quick charging systems for EVs, including CHAdeMO (predominantly used in Japan), the Combined Charging System (CCS) (predominantly used with non-Tesla vehicles), and Tesla's North American Charging Standard (NACS).

North America is currently seeing two competing standards being integrated into their EVs and used for charging of the EVs, the CCS and the NACS. Historically, Tesla has operated using their NACS connector, which is being standardized as SAE J3400. Most other manufacturers have historically used the CCS connector, standardized as SAE J1772. As noted above, this gives rise to the problem of EV charger inoperability with a given EV if their charging systems do not match. EV chargers have used various adaptors and adaptability systems in order to allow an EV charger to be compatible with both (or multiple) charging standards, with limited degrees of success.

The present application discloses an EV charger that is compatible with multiple charging standards by having two (or more) female ports which may be connected by a single cable.

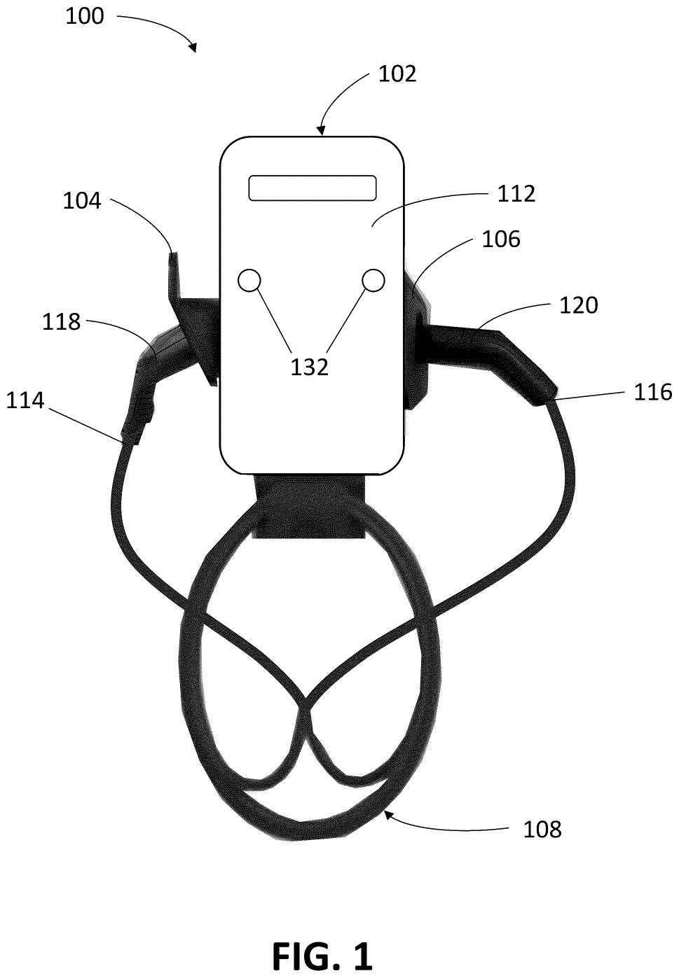

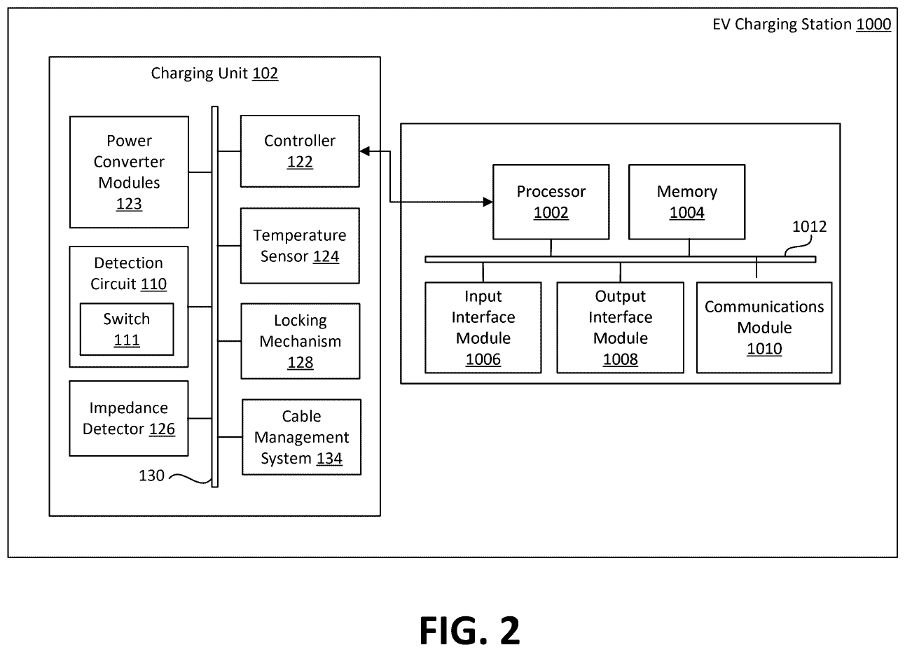

Reference is first made to FIG. 1, which illustrates a front view of an example EV charger 100. The EV charger 100 generally includes a main charging unit 102, a first port 104 and a second port 106 secured to the charging unit 102. The Ev charger 100 may further include a cable 108 that is configured to couple (and be connectable between) the first port 104 with the second port 106. As been seen in FIG. 2 the EV charger 100 includes a detection circuit 110 coupled to the first port 104 and the second port 106, and a switch 111 for selectively routing power through the first port 104 or the second port 106. The detection circuit 110 and the switch 111 may be operatively coupled together and positioned within the charging unit 102.

The first and second ports 104, 106 may be female ports, where the first port 104 is configured for a first charging system and the second port 106 is configured for a second charging system that is different from the first charging system. The first charging system may be configured to operate under a first charging standard and the second charging system may be configured to operate under a second charging standard, where the second charging standard is different from the first charging standard. In that regard, the first port 104 may have a first pin layout according to the first charging standard, while the second port 106 may have a second pin layout according to the second charging standard that is different from the first pin layout. For example, in FIG. 1, the first charging system may be the CCS and the second charging system may be the NACS. In that manner, the first port 104 may be a female CCS port (per SAE J1772) with the CCS pin layout and the second port 106 may be a female NACS port (per SAE J3400) with the NACS pin layout. In other implementations, the first or second charging system may be the CHAdeMO system or another fast-charging system for EVs. In that case, the corresponding female port(s) would also be configured according to the corresponding standard.

The cable 108 is adapted to couple the first port 104 with/and the second port 106. To that end, the cable 108 has at least one end 114 that may be coupled to the first port 104, and an opposed other end 116 that may be coupled to the second port 106. To couple the cable 108 with the first and second ports 104, 106, the implementation depicted in FIG. 1 further includes a first connector 118 and a second connector 120. The first connector 118 may be connected to the one end 114 of the cable 108 and the second connector 120 may be connected to the other end 116 of the cable 108. In other implementations, the one end 114 of the cable 108 may be releasably securable to first connector 118, and the other end 116 of the cable 108 may be releasably securable to second connector 120. The first and second connectors 118, 120 may be male connectors, where the first connector 118 is configured to be received within, and to be releasably securable, to the first port 104 of the EV charger 100 and to the input port of a compatible EV to charge the EV under the first charging system or standard. The second connector 120 is configured to be received within, and releasably securable, to the second port 106 of the EV charger 100 and to the input port of a compatible EV to charge the EV under the second charging system or standard. In the depicted implementation, since the first charging system is the CCS, the first connector 118 may be a male CCS connector (per SAE J1772). Since the second charging system is the NACS, the second connector 120 may be a male NACS connector (per SAE J3400). As mentioned above, if the first or second charging system was the CHAdeMO system or another fast-charging system, the corresponding male connector(s) would be also configured according to the corresponding standard.

Returning to the charging unit 102, the charging unit 102 may include a housing 112 which holds internal components of the EV charger 100, such as, among other things, a battery system, power converters (e.g., AC-to-DC converters), a charge controller, circuitry, and cables and connectors. In some implementations, the charging unit 102 may not include the power source and may, instead, be part of a charging system with distributed architecture. In that case, the charging unit 102 may be electrically coupled to a separate and/or remotely positioned power source, such as a power bank, a power engine, a power block, a power unit, or other power system (not shown).

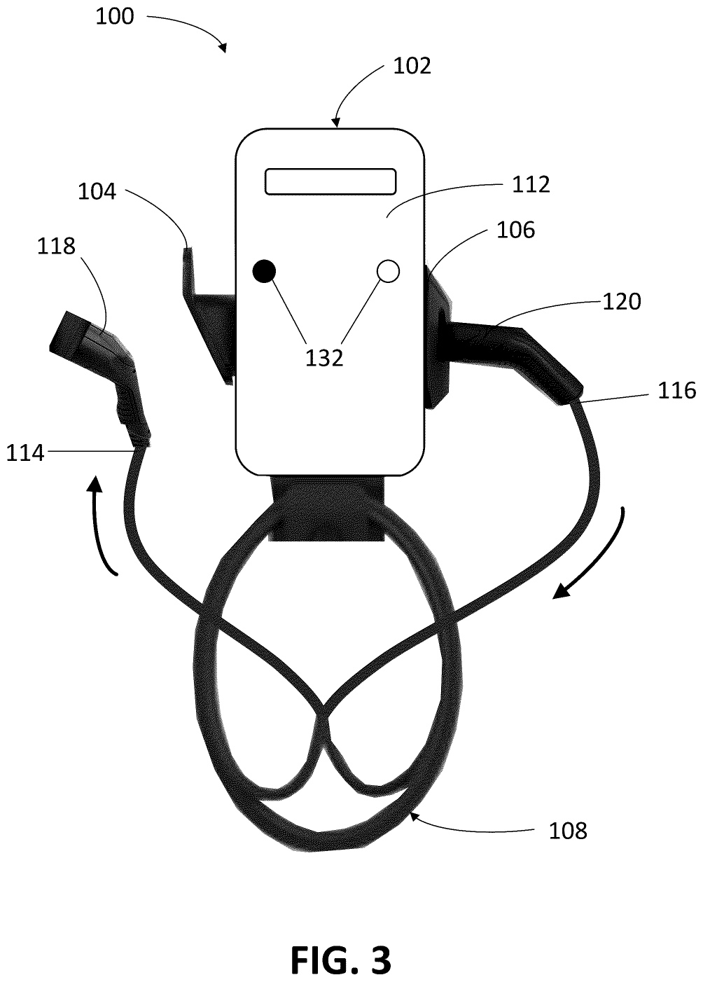

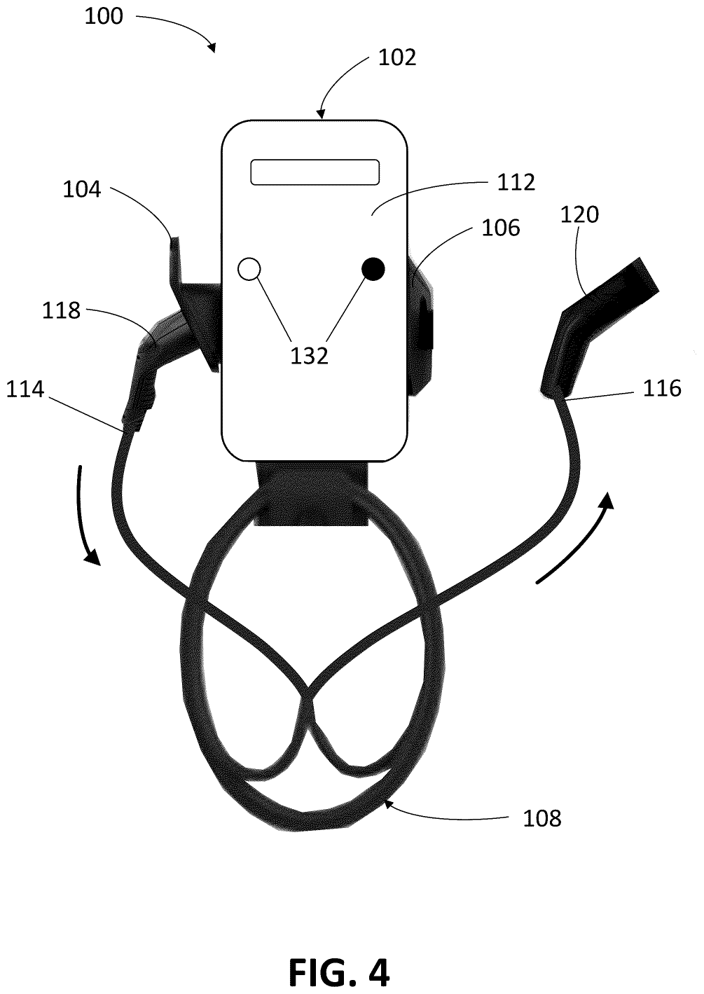

Reference is made to FIG. 2, which is a schematic diagram of some of the internal components of the EV charger 100 as part of an example EV charging station 1000. In the illustrated implementation, the EV charger 100 may include, and be controlled by, a controller 122 and have at least one power converter module 123, such as an AC-to-DC converter. As noted above, the present EV charger 100 includes the detection circuit 110, which may be positioned within the charging unit 102. The detection circuit 110 is coupled to the first port 104 and the second port 106 and is configured to detect whether the first port 104 or the second port 106 is in use. The first port 104 is considered to be “in use” when current is to be and is directed through the first port 104. The second port 106 is considered to be “in use” when current is to be and is directed through the second port 106. Notably, because the cable 108, in use, couples the first port 104 with the second port 106, the current is to be directed through the first port 104 when the second charging system is in use, and the current is to be directed through the second port 106 when the first charging system is in use (discussed further with regard to FIGS. 3 and 4).

To that end, the EV charger 100 also comprises the switch 111, which may also be positioned within the charging unit 102, for selectively routing power through the first port 104 or the second port 106. Notably, the switch 111 is adapted to route power through the first port 104 when the first port 104 or the second charging system is detected to be in use by the detection circuit 110, and route power through the second port 106 when the second port 106 or the first charging system is detected to be in use by the detection circuit 110.

The charging unit 102 may comprise a temperature sensor 124 coupled to the controller 122 and the power source (not shown). The temperature sensor 124 may be positioned and configured to take a temperature reading of the air within and/or around the EV charger 100. The temperature sensor 124 may alternatively be positioned and configured to take a temperature reading of a component of the EV charger 100. For example, the temperature sensor 124 may be operatively coupled to the cable 108 to detect the temperature reading of the cable 108. Based on the temperature reading from the temperature sensor 124, the controller 122 may be configured to send a signal to the power source to provide power to/send a current through the cable 108 when the cable 108 is connected to the first port 104 and the second port 106. In some implementations, the controller 122 may be configured to send the signal to the power source to provide power to the cable 108 when the temperature reading from the temperature sensor 124 falls outside a predetermined threshold, such as below a minimum threshold. This may be useful in cold climates or cold weather, where the cable 108 can become rigid and fragile due to low temperatures. Sending current through the cable 108 in such conditions can help to heat the cable 108 to keep it malleable.

In other implementations, the EV charger 100 may have multiple temperature sensors positioned at various locations to take temperature readings at various locations and/or of various components of the EV charger 100. In such a case, the controller 122 may be configured to send the signal to the power source to provide power to the cable 108 when the temperature readings from the multiple temperature sensors 124 satisfy predetermined parameters.

The charging unit 102 may further comprise an impedance detector 126 for measuring an impedance of the cable 108 when the cable 108 is also connected to the first port 104 and the second port 106. The impedance detector 126 may be coupled to the controller 122, where the controller 122 may be configured to trigger a notification when the impedance of the cable 108 indicates deterioration of the cable. In some implementations, the controller 122 may be configured to send a signal to the power source to pass a current through the cable 108, and the impedance detector 126 can determine the current drop across the cable 108. The impedance detector 126 may determine the resistance of the cable 108 and the controller 122 may use the resistance to evaluate the health of the cable 108. Typically, as the cable 108 ages, the resistance may be expected to increase. Thus, if the resistance exceeds a predetermined threshold, such as exceeds a maximum threshold, the controller 122 may be configured to trigger a notification or alert to notify a user or operator of the state of the cable 108. In this manner, the EV charger 100 may help to monitor the health of the cable 108 and may allow for remote monitoring.

The present implementation of charging unit 102 may also include a locking mechanism 128 operatively coupled to the first port 104, the second port 106, and the controller 122. The locking mechanism 128 may be configured to selectively lock the first connector 118 to the first port 104 and lock the second connector 120 to the second port 106 when the first port 104 and the second port 106 are detected to not be in use, or simply by default. To that end, the locking mechanism 128 may be in communication with the detection circuit 110 via the controller 122 for determining when the first port 104 and/or second port 106 are in use. The foregoing internal components of the charging unit 102 may be in communication over a charger bus 130.

The controller 122 may further be configured, based on completion of an authentication protocol, to send a signal to the locking mechanism 128 to unlock at least one of the first connector 118 from the first port 104 and the second connector 120 from the second port 106. In the implementation depicted in FIG. 2, the authentication protocol may be executed by the controller 122 or a (remote) processor 1002 of the EV charging station 1000.

The EV charging station 1000 may includes a variety of modules. For example, as illustrated, the EV charging station 1000, may include the processor 1002, a memory 1004, an input interface module 1006, an output interface module 1008, and a communications module 1010. As illustrated, the foregoing example modules of the EV charging station 1000 are in communication over a station bus 1012.

The processor 1002 is a hardware processor. The processor 1002 may, for example, be one or more ARM, Intel x86, PowerPC processors or the like.

The memory 1004 allows data to be stored and retrieved. The memory 1004 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the EV charging station 1000.

The input interface module 1006 allows the EV charging station 1000 to receive input signals. Input signals may, for example, correspond to input received from a user. The input interface module 1006 may serve to interconnect the EV charging station 1000 with one or more input devices (not shown). Input signals may be received from input devices by the input interface module 1006. Input devices may, for example, include one or more of a touchscreen input, keyboard, trackball, or the like. In some implementations, all or a portion of the input interface module 1006 may be integrated with an input device. For example, the input interface module 1006 may be integrated with one of the aforementioned example input devices. The input device may be directly connected to the EV charging station 1000, or may be a separate device (such as the user's personal device), in communication with the EV charging station 1000 via the communication module 1010.

The output interface module 1008 allows the EV charging station 1000 to provide output signals. Some output signals may, for example allow provision of output to a user. The output interface module 1008 may serve to interconnect the EV charging station 1000 with one or more output devices. Output signals may be sent to output devices by output interface module 1008. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 1008 may be integrated with an output device. For example, the output interface module 1008 may be integrated with one of the aforementioned example output devices. The output device may be directly connected to the EV charging station 1000, or may be a separate device (such as the user's personal device), in communication with the EV charging station 1000 via the communication module 1010.

The communications module 1010 allows the EV charging station 1000 to communicate with other electronic devices and/or various communications networks. For example, the communications module 1010 may allow the EV charging station 1000 to send or receive communications signals. Communications signals may be sent or received according to one or more protocols or according to one or more standards. For example, the communications module 1010 may allow the EV charging station 1000 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 1010 may allow the EV charging station 1000 to communicate using near-field communication (NFC), via Wi-Fi™, using Bluetooth™ or via some combination of one or more networks or protocols. Contactless payments may be made using NFC. In some implementations, all or a portion of the communications module 1010 may be integrated into a component of the EV charging station 1000. For example, the communications module may be integrated into a communications chipset.

Software comprising instructions is executed by the processor 1002 from a computer-readable medium. For example, software may be loaded into random-access memory from persistent storage of memory 1004. Additionally, or alternatively, instructions may be executed by the processor 1002 directly from read-only memory of memory 1004.

Thus, the authentication protocol may be executed by the processor 1002 (which may be remote) in communication with the memory 1004, the input interface module 1006, the output interface module 1008, and the communications module 1010, as known in the art.

In some implementations, one or more of the memory 1004, the input interface module 1006, the output interface module 1008, and the communications module 1010 may be located within the charging unit 102, in communication with the controller 122. In such an implementation, the charging unit 102 may itself have the input and output interfaces, and network connections to directly execute the authentication protocol as known in the art. For example, the authentication protocol may include verification of a payment method and/or verification of membership in a defined class of authorized users.

The controller 122 and the processor 1002 may further be configured to receive a charging system selection from the input interface module 1006. For example, the user may provide an input signal indicating which of the charging systems they wish to use to recharge the user's EV, such as the first or second charging system, which may be the CCS, NACS, or

CHAdeMO etc. Based on the charging system selection, the controller 122/the processor 1002 may be further be configured to send a signal to the locking mechanism 128 to unlock the corresponding first connector 118 from the first port 104 (if the first charging system was selected) or the second connector 120 from the second port 106 (if the second charging system was selected).

The charging unit 102 may further have an indicator 132, which may be coupled to the locking mechanism 128, that is configured to indicate which of the first and second connectors 118, 120 is unlocked. In the implementation depicted in FIG. 1, the indicator 132 comprises a pair of lights, one positioned beside each port 104, 106. For example, in some implementations, the light that is adjacent to the ends 114, 116 of the cable 108, or the ports 104, 106 that is to be used may be lit to indicate that the corresponding connector has been unlocked and is in use or ready for use. In other implementations, both lights may be red when the connectors are locked, and the light corresponding to the connector to be used may change to green when the corresponding connector is unlocked and ready for use. The indicator 132 may form a part of, or may be sperate from, the output interface module 1008.

The present implementation of charging unit 102 may also include a cable management system 134 coupled to the controller 122. Further to the charging system selection, the controller 122 and/or the processor 1002 may be further configured to send a signal to the cable management system 134 to selectively extend or retract the cable 108 based on the charging system selected. The cable management system 134 may be controlled based on which of the ports 104, 106 is in use. For example, the cable management system 134 may operate cable 108 differently when the first port 104 is in use than when the second port 106 is in use.

Given the above, the EV charger 100 may be compatible, and be used, with at least two different EV vehicles having different charging systems, different charging standards, and/or different predefined input pin layouts, see FIGS. 3 and 4 for example. As described, the switch 111 is adapted to selectively route power through the first port 104 or the second port 106. In the present implementation, the first port 104 is configured for the first charging system/standard (such as the CCS) and the second port 106 is configured for the second charging system/standard (such as the NACS). FIG. 3 illustrates the EV charger 100 in a first charging configuration when the first charging system is in use, where the first connector 118 may be decoupled from the first port 104 and may be coupled to a compatible CCS EV (not shown) for recharging. In the first charging configuration, the second port 106 is in use whereby the switch 111 routes the power/current out through the second port 106 (as indicated by the bold arrows in FIG. 3), the second connector 120, the cable 108, and then through the first connector 118 into the compatible CCS EV. FIG. 4 illustrates the EV charger 100 in a second charging configuration when the second charging system is in use, where the second connector 120 may be decoupled from the second port 106 and may be coupled to a compatible NACS EV (not shown) for recharging. In the second charging configuration, the first port 104 is in use whereby the switch 111 routes the power/current out through the first port 104 (as indicated by the bold arrows in FIG. 4), the first connector 118, the cable 108, and then through the second connector 120 into the compatible NACS EV. In such a manner, only one cable is necessary for charging at least two different EV vehicles under two different charging systems or standards.

In further implementations, the charging unit 102 may have three or more female charging ports, such as a third CHAdeMO or other fast-charging port, with a corresponding third connector that is electrically coupled or able to be coupled to the same cable 108 by a third end of the cable 108. In such cases, the switch 111 may be adapted to selectively route power through the first, second, and/or third ports. When the third connector is decoupled from the third port, for example, and the third connector is coupled to a compatible EV for recharging, the switch 111 may route the power/current out through the first and/or second ports, through the cable 108, and then through the third connector into the compatible EV. In this manner, the EV charger 100 may be compatible, and used, with three (or more) different EV vehicles, each having different charging systems.

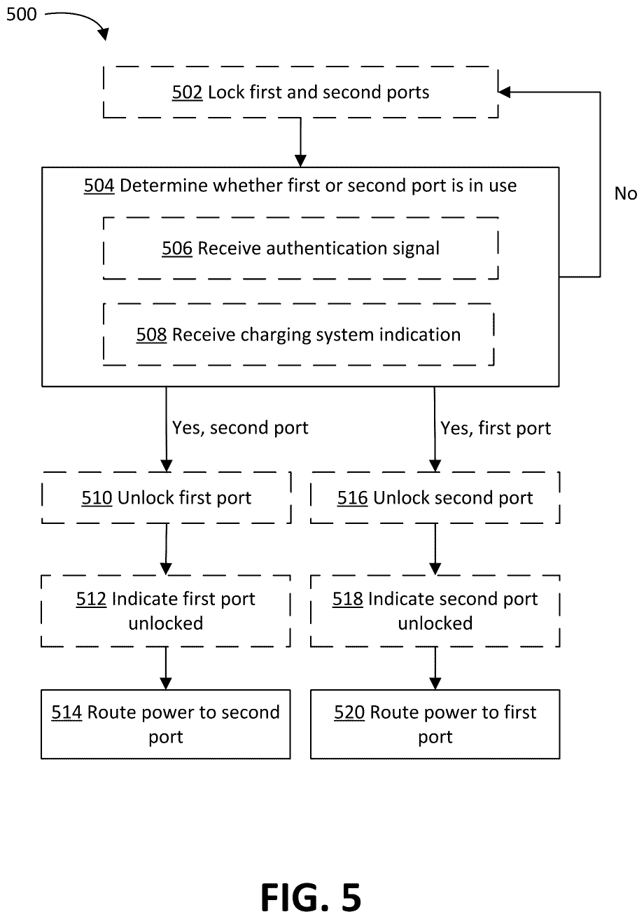

Turning now to FIGS. 5, 6, and 7, there is illustrated methods 500, 600, and 700 which may be performed by the EV charger 100 and the controller 122/processor 1002 as described herein. The methods 500, 600, and 700 may also be performed by other EV chargers and associated controllers.

Reference is made to FIG. 5, which shows, in flowchart form, an example method 500 for controlling operation of an EV charger. Specifically, the method 500 allows an EV charger to be robustly compatible with two or more EV vehicles for recharging, when each of the EV vehicles operates under different charging system standards. Operations 502 and onward may be performed by one or more processors associated with a controller of an EV charger and an EV charging station. In particular, a computing system that is configured to control functionalities of the EV charger may perform all or part of the operations of method 500.

Similar to that described above, the EV charger may generally include a charging unit, a first port and a second port secured to the charging unit, and a cable that is configured to couple (and be connectable between) the first port with/and the second port. The first port is configured for a first charging system and the second port is configured for a second charging system that is different from the first charging system. The first charging system may operate under a first charging standard and the second charging system may operate under a second charging standard, where the second charging standard is different from the first charging standard. In that regard, the first port 104 may have a first pin configuration according to the first charging standard, while the second port 106 may have a second pin configuration according to the second charging standard that is different from the first pin configuration.

The EV charger may also include a detection circuit coupled to the first port and the second port, and a switch for selectively routing power through the first port or the second port. The EV charger may further include a first connector that may be connected or releasably secured to one end of the cable, and a second connector that may be connected or releasably secured to the other end of the cable. The first connector is releasably couplable with the first port and the second connector is releasably couplable with the second port.

In operation 502, the controller of the EV charger may first send a signal to lock the first and second ports, such as when they are not in use, for security purposes and to prevent unauthorized use. To that end, the signal may be sent to lock the first connector within the first port, and to lock the second connector within the second port. In some implementations, the first and second ports of the EV charger may simply be in the locked state as a default state. In other implementations, the first and second ports of the EV charger may simply be in an unlocked state as the default state.

In operation 504, the controller determines whether the first or second port is in use. In some implementations, the controller may determine whether the first or second port is in use by detecting or receiving a signal from a weight or current sensor coupled to the first and second ports, where the signal indicates whether the first or second connector has been removed from its corresponding port. In such an implementation, if the first connector has been removed from the first port, the controller determines that the first charging system is desired, whereby the second port is in use (i.e. power/current is to be directed through the second port). If the second connector has been removed from the second port, the controller determines that the second charging system is desired, whereby the first port is in use (i.e. power/current is to be directed through the first port).

In other implementations, the controller may determine that the first and second ports are not in use until it receives an authentication signal in operation 506. The authentication signal may indicate that a payment method by the user has been verified and/or may indicate that the user has verified his/her membership in a defined class of authorized users. Other forms of authentication protocols may be used. Additionally or alternatively, the controller may determine that the first or second port is in use when it receives a charging system indication in operation 508. The charging system indication may indicate a selection by the user of which charging system or standard (first or second, CCS or NACS for example) they wish to use. The authentication signal and the charging system indication may be received via an input interface module integrated with an input device. The input device may be directly connected to the EV charging station, or it may be a separate device (such as the user's personal device), in communication with the EV charger via a communication module.

If the controller determines that neither the first port nor the second port are in use, that no authentication signal was received, and/or that no charging system indication was received, the method 500 may return to operation 502, where the first and second ports remain locked. If the controller determines that the first port or the second port are in use, that an authentication signal has been received, and/or that a charging system indication has been received, the method 500 may progress to operation 510 or 516.

If the controller determines that the first charging system is desired and the second port is in use (i.e. power/current is to be directed through the second port), the controller may send a signal to unlock the first port in operation 510. In some implementations, for example, the first connector may be unlocked from the first port and the second connector may remain locked in the second port. Simultaneously or consecutively, at operation 512, the controller may also send a signal to an indicator to indicate that the first port is unlocked. If the indicator is a visual indicator, like a light positioned adjacent to the first port, the light may be lit to indicate that the first port is unlocked. Alternatively, the light may have been red to indicate that the first port was locked, and the signal instructs the light to change from red to green to indicate that the first port is unlocked. Other visual or audible indicators as known in the art may be used in other implementations to indicate that the first port is unlocked.

In operation 514, after the controller determines that the first charging system is desired and the second port is in use, the controller then sends a signal to the switch to route power/current to the second port. In this first charging configuration, the switch routes the current through the second port (as indicated by the bold arrows in FIG. 3), the second connector, the cable, and then through the first connector into the EV that is configured under the first charging system.

If the controller determines that the second charging system is desired and the first port is in use at operation 504 (i.e. power/current is to be directed through the first port), the controller may send a signal to unlock the second port at operation 516. In some implementations, for example, the second connector may be unlocked from the second port and the first connector may remain locked in the first port. Simultaneously or consecutively, at operation 518, the controller may also send a signal to an indicator to indicate that the second port is unlocked. The indicator may be a visual indicator, as described above, and positioned adjacent to the second port. The light may be lit to indicate that the second port is unlocked or may turn from red to green to indicate that the second port is unlocked. Other visual or audible indicators may be used in other implementations.

In operation 520, after the controller determines that the first port is in use, the controller then sends a signal to the switch to route power/current to the first port. In this second charging configuration, the switch routes the current through the first port (as indicated by the bold arrows in FIG. 4), the first connector, the cable, and then through the second connector into the EV that is configured under the second charging system.

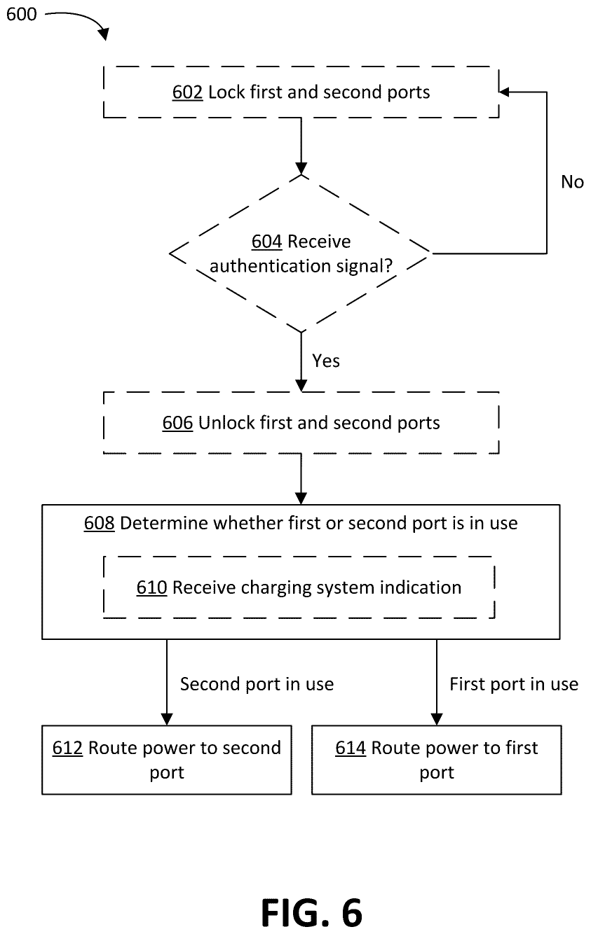

An alternative method 600 that may be performed by the EV charger 100 and the controller 122/processor 1002 is shown in FIG. 6. The operations of method 600 may be performed as an alternative of the operations of method 500.

In operation 602, similar to operation 502, the controller of the EV charger may send a signal to lock the first and second ports, such as by locking the first connector within the first port, and the second connector within the second port.

In operation 604, the controller determines whether an authentication signal has been received. The authentication signal may indicate that a payment method by the user has been verified and/or may indicate that the user has verified his/her membership in a defined class of authorized users. Other forms of authentication protocols may be used. The authentication signal may be received via an input interface module integrated with an input device. The input device may be directly connected to the EV charger or the EV charging station, or it may be a separate device (such as the user's personal device), in communication with the EV charger via a communication module.

If the controller determines that no authentication signal was received, the method 600 may return to operation 602, where the first and second ports remain locked. If the controller determines that an authentication signal has been received, the method 600 may progress to operation 606, where the controller sends a signal to unlock both the first and second ports. In that manner, the first connector may be unlocked from the first port, and the second connector may be unlocked from the second port.

In operation 608, the controller determines whether the first or second port is in use. In some implementations, the controller may determine whether the first or second port is in use by detecting or receiving a signal from a weight or current sensor coupled to the first and second ports, where the signal indicates whether the first or second connector has been removed from its corresponding port. In such an implementation, removal of the first connector from the first port may indicate that the first charging system is desired, and the second port is in use. Conversely, removal of the second connector from the second port may indicate that the second charging system is desired, and the first port is in use. In this manner, the user may indicate which charging system or standard they wish to use (first or second, CCS or NACS for example) by simply removing the correct connector from its corresponding port.

Alternatively, the controller may determine that the first or second port is in use when it receives a charging system indication in operation 610. The charging system indication may indicate a selection by the user of which charging system (first or second, CCS or NACS for example) they wish to use. The charging system indication may be received via an input interface module integrated with the input device. The input device may be directly connected to the EV charging station, or it may be a separate device (such as the user's personal device), in communication with the EV charger via the communication module.

If the controller determines that the first charging system is desired and the second port is in use, in operation 612, the controller then sends a signal to the switch to route power/current to the second port and the first connector may be removed from the first port. As described above, in this first charging configuration, the switch routes the current through the second port (as indicated by the bold arrows in FIG. 3), the second connector, the cable, and then through the first connector into the EV that is configured under the first charging system or standard.

If the controller determines that the second charging system is desired and the first port is in use, in operation 614, the controller then sends a signal to the switch to route power/current to the first port. In this second charging configuration, the switch routes the current through the first port (as indicated by the bold arrows in FIG. 4), the first connector, the cable, and then through the second connector into the EV that is configured under the second charging system.

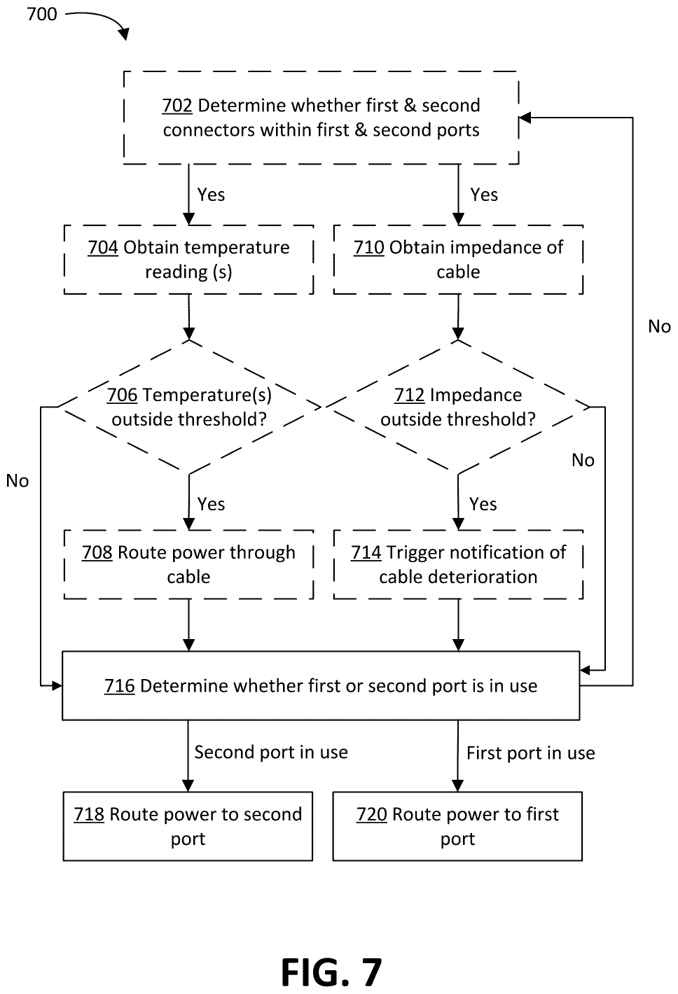

A further method 700, that may be performed by the EV charger 100 and the controller 122/processor 1002, is shown in FIG. 7. The operations of method 700 may be performed in addition to, or as alternatives of, one or more of the operations of methods 500 and 600.

In operation 702, the controller of the EV charger may determine whether the cable is connected at the first port and the second port. In some implementations, that may mean the controller determining whether both the first and second connectors are coupled within/connected to the first and second ports. When they are, the first and second ports are connected by the cable. In some the implementations, the first and second connectors may also be locked within the respective first and second ports.

If the controller determines that both the first and second connectors are coupled within/connected to the first and second ports, in operation 704, the controller may obtain one or more temperature reading(s) of the EV charger. The temperature reading(s) may be of the air within and/or around the EV charger 100 or may be of a component of the EV charger. For example, a temperature reading of the cable may be obtained.

In operation 706, the controller may then determine whether the temperature reading(s) fall outside a predetermined threshold or predetermined parameters, such as if the temperature reading falls below a minimum threshold. If the temperature reading(s) is/are within the predetermined threshold or parameters, the method 700 progresses to operation 716, where the controller determines whether the first or second port is in use (as described above in operations 504 and 608). If the temperature reading(s) is/are outside the predetermined threshold/parameters, such as if the temperature reading falls below the minimum threshold, the method 700 progresses to operation 708, where the controller sends a signal to route power/current through the cable. As noted above, this may be useful in cold climates or cold weather, where the cable can become rigid and fragile due to low temperatures. Sending current through the cable in such conditions can help to heat the cable to keep it malleable.

Alternatively or additionally, if the controller determines that the cable is connected at the first port and the second port (such as if both the first and second connectors are coupled within/connected to the first and second ports), in operation 710, the controller may determine or obtain an impedance reading of the cable. In some implementations, the controller may send a signal to the power source to pass a current through the cable for an impedance detector to determine the current drop across the cable. The impedance detector may determine the resistance of the cable and the controller may use the resistance to evaluate the health of the cable.

In operation 712, the controller may then determine whether the impedance or resistance level of the cable falls outside a predetermined threshold, such as if the resistance level exceeds a maximum threshold. If the resistance level is within the predetermined threshold, the method 700 progresses to operation 716, where the controller determines whether the first or second port is in use (as described above in operations 504 and 608). If the resistance level is outside the predetermined threshold, such as if the resistance level exceeds the maximum threshold, the method 700 progresses to operation 714, where the controller triggers a notification or alert of the cable's deterioration to an operator or user. In this manner, the EV charger may help to monitor the health of the cable and may allow for remote monitoring.

At operation 716, the controller determines whether the first or second charging system is desired and whether the first or second port is in use. In operation 718, if the controller determines that the second port is in use (i.e. the first charging system is desired), the controller then sends a signal to a switch to route power/current to the second port (as described above in operations 514 and 612). In operation 720, if the controller determines that the first port is in use (i.e. the second charging system is desired), the controller then sends a signal to the switch to route power/current to the first port (as described above in operations 520 and 614).

Given the above, methods 500, 600, and 700 allow an EV charger to be compatible, and be used, with at least two different EV vehicles having different charging systems or different charging standards. In one charging configuration, the switch routes the power/current out through the second port, the second connector, the cable, and then through the first connector into a compatible first EV (see FIG. 3 for example). In another charging configuration, the switch routes the power/current out through the first port, the first connector, the cable, and then through the second connector into a compatible second EV (see FIG. 4, for example). In such a manner, only one cable is necessary for charging at least two different EV vehicles under two different charging systems or standards.

The various implementations presented above are merely examples and are in no way meant to limit the scope of this application. Variations of the innovations described herein will be apparent to persons of ordinary skill in the art, such variations being within the intended scope of the present application. In particular, features from one or more of the above-described example implementations may be selected to create alternative example implementations including a sub-combination of features which may not be explicitly described above. In addition, features from one or more of the above-described example implementations may be selected and combined to create alternative example implementations including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. An EV charger comprising:
a first port configured for a first charging system;
a second port configured for a second charging system;
a detection circuit coupled to the first port and the second port, the detection circuit configured to detect whether the first charging system or the second charging system is to be in use; and
a switch for selectively routing power through the first port when the second charging system is detected to be in use, and through the second port when the first charging system is detected to be in use.

2. The EV charger of claim 1, further comprising a cable configured to couple at one end to the first port and at another end to the second port.

3. The EV charger of claim 2, further comprising:
a temperature sensor; and
a controller coupled to the temperature sensor and a power source, the controller configured to, based on a temperature reading at the temperature sensor, send a signal to the power source to provide power to the cable when the cable is connected to the first port and the second port.

4. The EV charger of claim 3, wherein the temperature sensor is operatively coupled to the cable to detect the temperature reading of the cable.

5. The EV charger of claim 2, further comprising:
an impedance detector for measuring an impedance of the cable when the cable is connected to the first port and the second port; and
a controller configured to trigger a notification when the impedance of the cable indicates deterioration of the cable.

6. The EV charger of claim 2, further comprising:
a first connector coupled to the one end of the cable and releasably securable to the first port, the first connector configured to releasably couple with an EV to charge the EV under the first charging system; and
a second connector coupled to the other end of the cable and releasably securable to the second port, the second connector configured to releasably couple with another EV to charge the other EV under the second charging system.

7. The EV charger of claim 6, further comprising:
a locking mechanism operatively coupled to the first port and the second port, the locking mechanism configured to selectively lock the first connector to the first port and lock the second connector to the second port when the first port and the second port are detected to not be in use.

8. The EV charger of claim 7, further comprising:
a controller coupled to the locking mechanism, the controller configured, based on completion of an authentication protocol, to send a signal to the locking mechanism to unlock at least one of the first connector from the first port and the second connector from the second port.

9. The EV charger of claim 8, wherein the controller is configured, based on a charging system selection, to send the signal to the locking mechanism to unlock the first connector from the first port when the first charging system is selected, or to unlock the second connector from the second port when the second charging system is selected.

10. The EV charger of claim 9, further comprising:
an indicator coupled to the locking mechanism configured to indicate which of the first and second connector is unlocked.

11. The EV charger of claim 2, further comprising:
a cable management system coupled to the cable; and
a controller coupled to the cable management system, the controller configured to send a signal to the cable management system to selectively extend or retract the cable based on a charging system selection.

12. A processor-implemented method, comprising:
determining whether a first charging system or a second charging system of an EV charger is to be in use, the EV charger having a first port configured for the first charging system, and a second port configured for the second charging system; and
in response to the determination, selectively routing power through the first port when the second charging system is detected to be in use, and through the second port when the first charging system is detected to be in use.

13. The method of claim 12, wherein the first port is connectable to the second port via a cable extending therebetween.

14. The method of claim 13, further comprising:
obtaining a temperature reading from a temperature sensor; and
providing power to the cable when the temperature reading falls below a predetermined threshold, and when the cable is connected at the first port and the second port.

15. The method of claim 13, further comprising:
obtaining an impedance of the cable when the cable is connected at the first port and the second port; and
triggering a notification when the impedance of the cable indicates deterioration of the cable.

16. The method of claim 13, wherein a first connector is coupled to one end of the cable and is releasably securable to the first port, the first connector being configured to releasably couple with an EV to charge the EV under the first charging system; and wherein a second connector is coupled to another end of the cable and releasably securable to the second port, the second connector being configured to releasably couple with another EV to charge the other EV under the second charging system.

17. The method of claim 16, further comprising:
locking the first connector within the first port and locking the second connector within the second port when the EV charger is detected to not be in use.

18. The method of claim 17, further comprising:
selectively unlocking the first connector from the first port when the first charging system is detected to be in use, and selectively unlocking the second connector from the second port when the second charging system is detected to be in use.

19. The method of claim 17, further comprising:
receiving indication of completion of an authentication protocol; and
unlocking at least one of the first connector from the first port and the second connector from the second port.

20. A non-transitory computer-readable medium storing instructions that, when executed by a processor of an EV charger, causes the processor to:
obtain a detecting signal indicating whether a first charging system or a second charging system of the EV charger is to be in use, the EV charger having a first port configured for the first charging system, and a second port configured for the second charging system; and
in response to the detecting signal, selectively route power through the first port when the second charging system is detected to be in use, and through the second port when the first charging system is detected to be in use.
